(19) United States
(12) Patent Application Publication
(10) Pub. No.: US 2012/0099330 A1
(43) Pub. Date: Apr. 26, 2012

(54) LAMPSHADE

(76) Inventor: Shu-Fang LI, Taichung City (TW)

(21) Appl. No.: 13/186,729

(22) Filed: Jul. 20, 2011

(30) Foreign Application Priority Data
Oct. 26, 2010 (TW) 099220659

(51) Int. Cl. F21V 1/00

(52) U.S. Cl. 362/351

(57) ABSTRACT

A lampshade of the present invention includes a main body and several supporting plates. The main body has a top ring, a bottom ring, a lamp holding ring, and supporting poles connecting the bottom ring to the lamp holding ring. An outer shade is attached to the top ring and the bottom ring. The supporting plates are buckled to the top ring and the bottom ring so as to prop the main body up. The supporting plates are detachable from the main body, so that the lamp shade could be stored and transported with a minimized space. Thus, cost of storage and transportation is well controlled.

### BACKGROUND OF THE INVENTION

1. Field of the Invention

The present invention relates to a lampshade for lighting device, and more particularly to a foldable lampshade.

2. Description of the Prior Art

Conventional lampshade, as disclosed in TW patent No. 1263009, includes supporting poles which are firmly disposed on lampstand. Further, light transmitted structure is annularly disposed around the supporting poles. Thus, light passing through the lampshade would be softened by the light transmitted structure.

Though light could be softened by using the lampshade, however, the lampshade has a solid structure and appearance. It would take a considerable space for storing the lampshade. As a result, cost of storage and transportation is raised.

The present invention is, therefore, arisen to obviate or at least mitigate the above mentioned disadvantages.

### SUMMARY OF THE INVENTION

The main object of the present invention is to provide a lampshade which is foldable for minimizing the space the lampshade occupied, so that the cost of storage and transportation would be under controlled.

To achieve the above and other objects, a lampshade of the present invention includes a main body and one or more supporting plates.

The main body has a circular bottom ring. A lamp holding ring is disposed in middle of the bottom ring. Plural supporting poles connect the lamp holding ring to the bottom ring. A circular top ring is disposed upon middle of the bottom ring. A width of the top ring is sized between a width of the bottom ring and a width of the lamp holding ring. A position of the top ring is higher than a position of the lamp holding ring. An outer shade is disposed annularly on the top ring and the bottom ring. The outer shade is made of light transmitted cloth. The outer shade has an upper piped edge and a lower piped edge. The upper piped edge and the lower piped edge encircle the top ring and the bottom ring inwardly respectively so as to bind to the top ring and the bottom ring.

The supporting plate is light transmitted. The supporting plate is symmetrically bent as scalloped plate. The supporting plate is disposed inside of the outer shade. Top edge and bottom edge of the supporting plate are respectively formed with upper engagement edge and lower engagement edge. The upper engagement edge is buckled to the top ring. The lower engagement edge is buckled to the bottom ring. As such, the outer shade and the top ring are propped up and supported stably by the supporting plate.

In some cases, the lampshade further comprises four said supporting poles. The four supporting poles are annularly arranged equidistantly along the bottom ring and the lamp holding ring. The supporting plate is formed with a notch on middle of the bottom edge thereof. Each of the notches receives one of the supporting poles therein.

In some cases, further plural pieces of guiding cloth are disposed on a outer side of the outer shade. The pieces of guiding cloth are annularly arranged equidistantly along the outer shade. The pieces of guiding cloth are light transmitted and formed as strips. Top portions and bottom portions of the pieces of guiding cloth cover and bind to the upper piped edge and the lower piped edge respectively.

In some cases, the lampshade comprises two said supporting plates. The supporting plates are annularly arranged and extend along the outer shade.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a preferred embodiment of the present invention;

FIG. 2 is a stereogram showing a preferred embodiment of the present invention;

FIG. 3 is a profile showing a preferred embodiment of the present invention;

FIG. 4 is a breakdown drawing showing a preferred embodiment of the present invention when the supporting plates are detached;

FIG. 5 is a schematic drawing showing a preferred embodiment of the present invention when the supporting plates are being fabricated;

FIG. 6 is a schematic drawing showing a preferred embodiment of the present invention when the supporting plates are being fabricated.

### DETAILED DESCRIPTION OF THE PREFERRED EMBODIMENTS

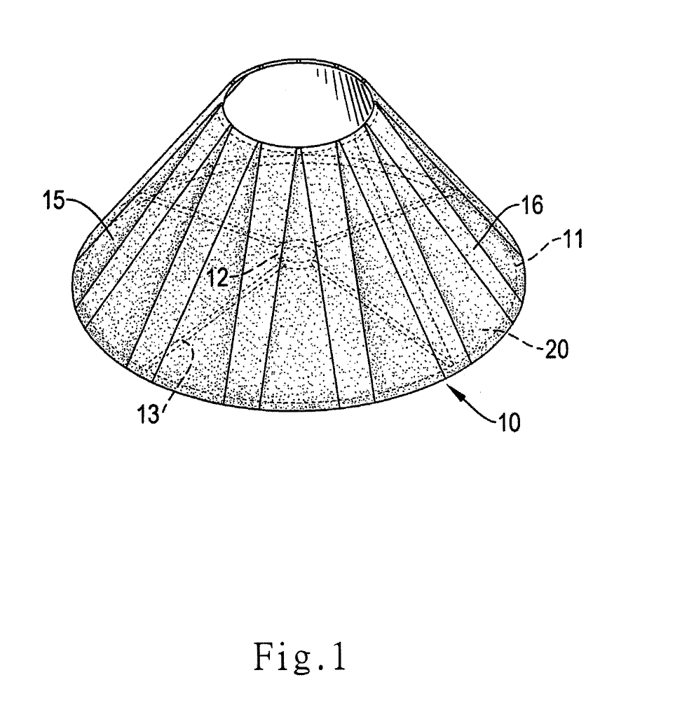

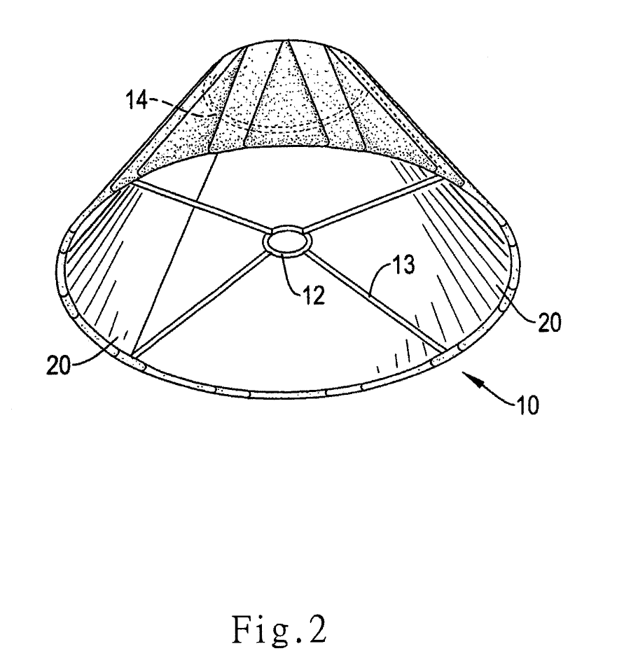

Please refer to FIG. 1 to FIG. 3 for a preferred embodiment of the present invention. The lampshade of the present embodiment includes a main body 10 and two supporting plates 20.

The main body 10 has a circular bottom ring 11 which is placed on the flat. A lamp holding ring 12, which is slight higher than the bottom ring 11, is disposed in middle of the bottom ring 11, being place on the flat, also. Four supporting poles 13, which are annularly arranged equidistantly along the bottom ring 11 and the lamp holding ring 12, connect the lamp holding ring 12 to the bottom ring 11. The supporting poles 13 are straight poles, being connected to the lamp holding ring 12 and the bottom ring 11 by two ends thereof. More particularly, each of the supporting poles 13 has two ends which are respectively connected to the lamp holding ring 12 and the bottom ring 11. A circular top ring 14 is disposed upon middle of the bottom ring 11. The top ring 14 and the bottom ring 11 are concentric. It is noted that the top ring 14 located at a different level from the bottom ring 11. The term concentric means that the top ring 14 and the bottom ring 11 have the same center in top view. A width of the top ring 14 is sized between a width of the bottom ring 11 and a width of the lamp holding ring 12. A position of the top ring 14 is higher than a position if the lamp holding ring 12. In other words, the top ring 14 is located higher than the lamp holding ring 12.

An outer shade 15 is disposed annularly on the top ring 14 and the bottom ring 11, receiving the top ring 14 and the bottom ring 11 therein. The outer shade 15 is made of light transmitted cloth which is stretchable. The outer shade 15 has an upper piped edge 151 and a lower piped edge 152. The upper piped edge 151 encircles the top ring 14 inwardly and is bound to the top ring 14. Thus, the top ring 14 is enrobed with the upper piped edge 151, and the outer shade 15 is firmly connected to the top ring 14. Similarly, the lower piped edge 152 encircles the bottom ring 11 inwardly and is bound to the bottom ring 11. Thus, the bottom ring is enrobed with the lower piped edge 152, and the outer shade 15 is firmly connected to the bottom ring 11. Further, several pieces of guiding cloth 16 are disposed on an outer side of the outer shade 15. The pieces of guiding cloth 16 are annularly arranged equidistantly along the outer shade 15. The pieces of guiding cloth 16 are light transmitted and formed as strips. Top portions and bottom portions of the pieces of cloth 16 cover and bind to the upper piped edge 151 and the lower piped edge 152 respectively.

The supporting plates 20 are light transmitted. Further, the supporting plates 20 are flexible, bent symmetrically as scalloped plate. More particularly, an arc length of a top edge of the supporting plate 20 is shorter than an arc length of a bottom edge of the supporting plate 20. The supporting plates 20 are annularly and symmetrically arranged and extend along the outer shade 15. The supporting plates 20 are bent inwardly so as to facing to each other. Each of side edges of the supporting plates 20 is contacted to the adjacent side edge. Thus, the supporting plates 20 stretch to combine with each other to achieve a strengthened structure. Each of the supporting plates 20 is formed with a notch 21 on middle of the bottom edge thereof. Each of the notches 21 receives on of the supporting poles 13 therein. Each of the supporting plates 20 is disposed inside of the outer shade 15, so that the supporting plates 20 are attached to the outer shade 15. Top edge and bottom edge of the supporting plate 20 are respectively formed with an upper engagement edge 22 and a lower engagement edge 23. The upper engagement edge 22 is buckled to the top ring. The lower engagement edge 23 is buckled to the bottom ring. Thus, the outer shade 15 and the top ring 14 are propped up and supported stably by the supporting plates 20.

The lamp holding ring 12 is positioned higher than the bottom ring 11 in the present embodiment. In other possible embodiments of the present invention, the lamp holding ring 12 and the bottom ring 11 may be positioned on a same level. Further, the quantity of the supporting poles 13 may be changed into two, three, or others, and the supporting poles 13 could still be annularly arranged. Similarly, the quantity of the supporting plates 20 may be changed arbitrarily.

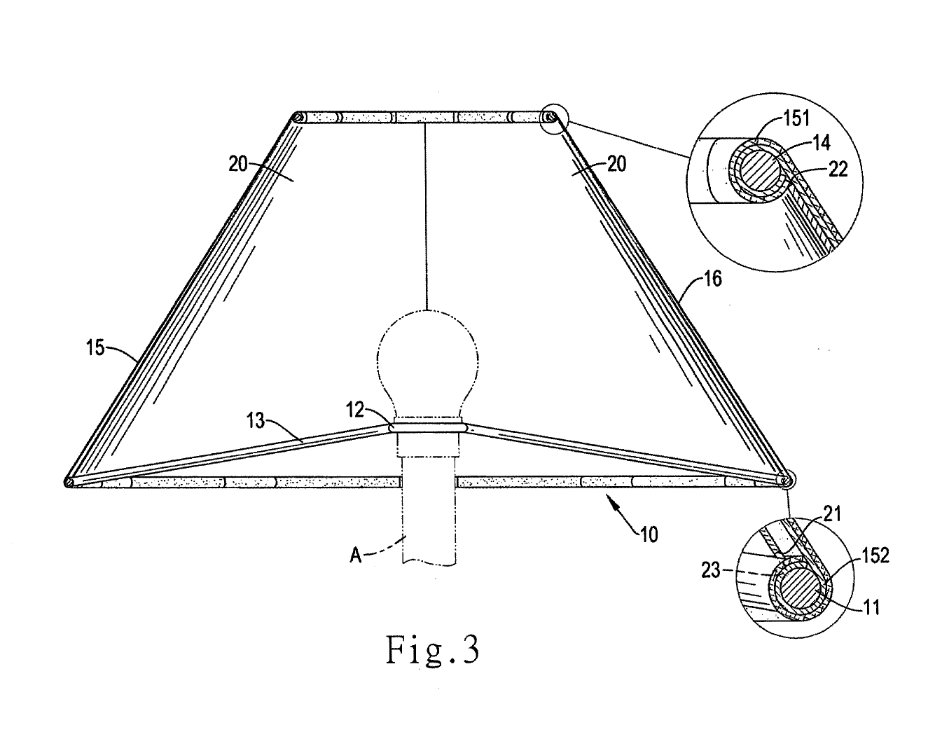

Please refer to FIG. 3, the lamp holding ring 12 embraces stably on the lampstand A. The supporting plates 20 and the outer shade 15 are transmitted, so that light generated by the lamp could pass through the supporting plates 20 and the outer shade 15 outwardly.

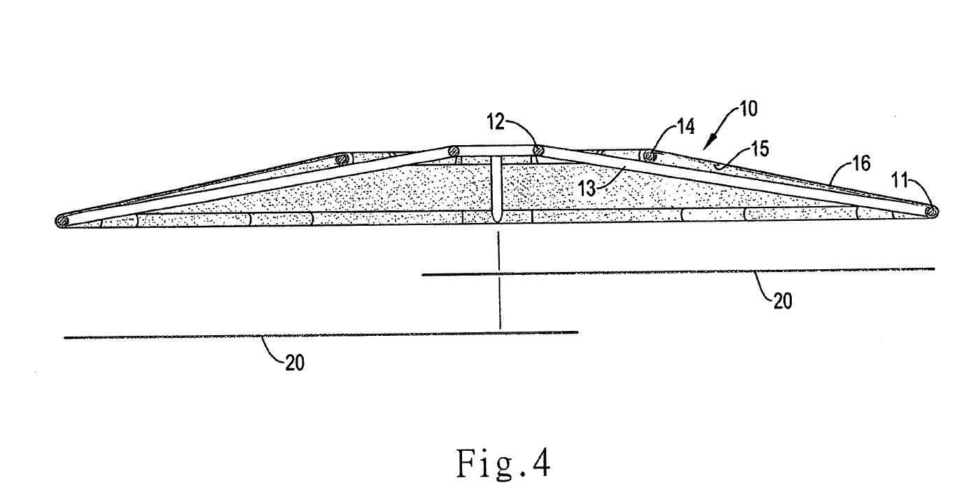

For storage or transportation purposes, as shown in FIG. 4, the supporting plates 20 may be detached from the main body 10 and piled up with the main body 10. The top ring 14 and the outer shade 15 are unsupported. Thus, the top ring 14 could be piled up with the supporting poles 13. The outer shade 15 is also creased. As such, the lampshade is flattened. Cost of storage or transportation is minimized.

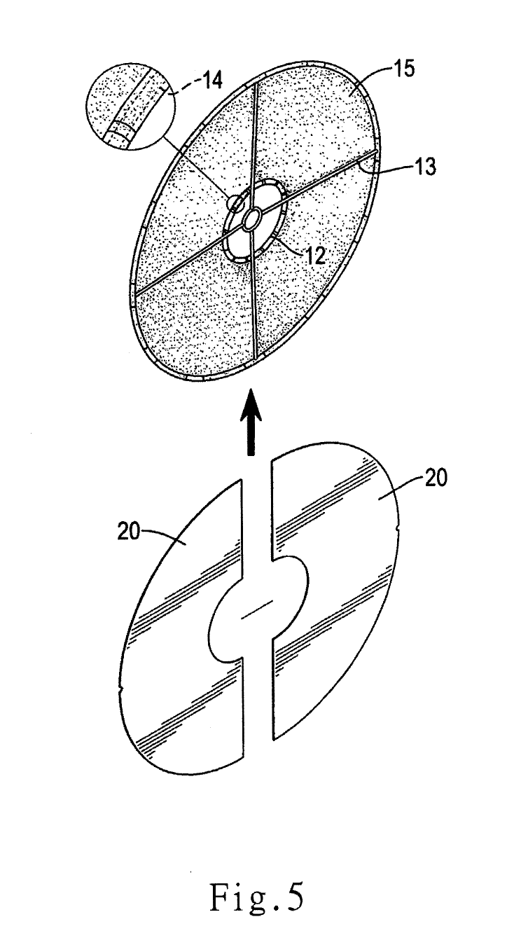

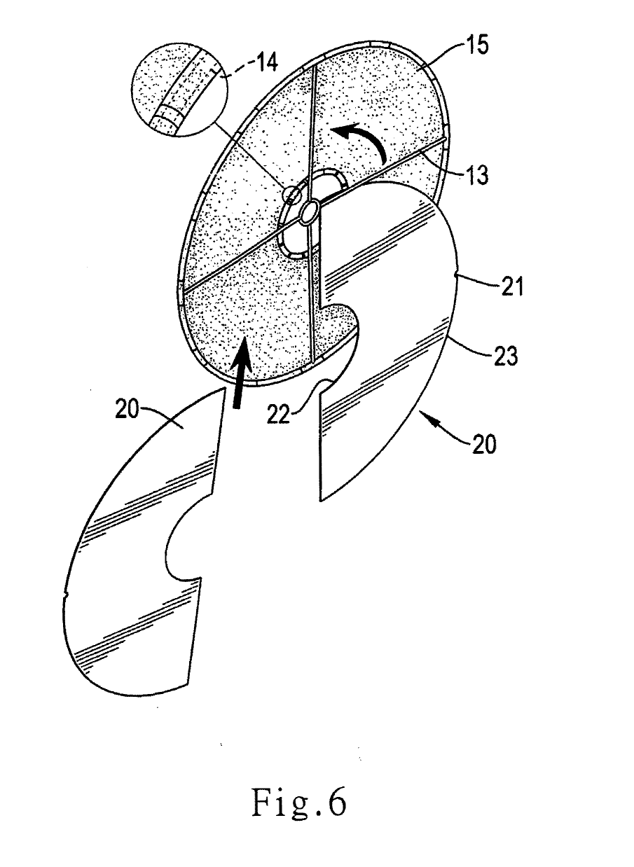

On the other hand, when fabricating the main body 10 and the supporting plates 20, as shown in FIG. 5 and FIG. 6, the supporting plates 20 are inserted into the outer shade 15 via the gap between two supporting poles 13. The top ring 14 is then taken up to draw the outer shade 15 to be fastened. The guiding cloth 16 could correct position of the main body 10 with the tension force thereof, so that the outer shade 15 could show up without torsion. The supporting plates 20 are then bent inwardly, as shown in FIG. 3. The upper engagement edge 22 is buckled to the top ring 14, and the lower engagement edge 23 is buckled to the bottom ring 11. The supporting poles 13 are received in the notches 21. Thus, the lampshade is then completed for using.

What is claimed is:

1. A lampshade, comprising:
a main body, having a circular bottom ring, a lamp holding ring being disposed in middle of the bottom ring, plural supporting poles connecting the lamp holding ring to the bottom ring, a circular top ring being disposed upon middle of the bottom ring, a width of the top ring being sized between a width of the bottom ring and a width of the lamp holding ring, a position of the top ring being higher than a position of the lamp holding ring, an outer shade being disposed annularly on the top ring and the bottom ring, the outer shade being made of light transmitted cloth, the outer shade having an upper piped edge and a lower piped edge, the upper piped edge and the lower piped edge encircling the top ring and the bottom ring inwardly respectively so as to bind to the top ring and the bottom ring; and
at least one supporting plate, being light transmitted, the supporting plate being symmetrically bent as scalloped plate, the supporting plate being disposed inside of the outer shade, top edge and bottom edge of the supporting plate being respectively formed with upper engagement edge and lower engagement edge, the upper engagement edge being buckled to the top ring, the lower engagement edge being buckled to the bottom ring, so that the outer shade and the top ring are propped up and supported stably by the supporting plate.

2. The lampshade of claim 1, wherein the lampshade comprises four said supporting poles, the four supporting poles are annularly arranged equidistantly along the bottom ring and the lamp holding ring, the supporting plate is formed with a notch on middle of the bottom edge thereof, each of the notches receives one of the supporting poles therein.

3. The lampshade of claim 1, wherein plural pieces of guiding cloth are disposed on a outer side of the outer shade, the pieces of guiding cloth are annularly arranged equidistantly along the outer shade, the pieces of guiding cloth are light transmitted and formed as strips, top portions and bottom portions of the pieces of guiding cloth cover and bind to the upper piped edge and the lower piped edge respectively.

4. The lampshade of claim 2, wherein plural pieces of guiding cloth are disposed on an outer side of the outer shade, the pieces of guiding cloth are annularly arranged equidistantly along the outer shade, the pieces of guiding cloth are light transmitted and formed as strips, top portions and bottom portions of the pieces of guiding cloth cover and bind to the upper piped edge and the lower piped edge respectively.

5. The lampshade of claim 3, wherein the lampshade comprises two said supporting plates, the supporting plates are annularly arranged and extend along the outer shade.

6. The lampshade of claim 4, wherein the lampshade comprises two said supporting plates, the supporting plates are annularly arranged and extend along the outer shade.
